(19) United States
(12) Patent Application Publication
(10) Pub. No.: US 2006/0053249 A1
(43) Pub. Date: Mar. 9, 2006

(54) Information recording/reproduction processing device, method, and computer program

(75) Inventors: Makio Yamaki, Kanagawa (JP); Junji Oiwa, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 10/532,260

(22) PCT Filed: Oct. 27, 2003
(86) PCT No.: PCT/JP03/13695

§ 371 Date: Apr. 21, 2005

(30) Foreign Application Priority Data
Oct. 28, 2002 (JP) 2002-312163

(51) Int. Cl. G06F 12/00

(52) U.S. Cl. 711/112

(57) ABSTRACT

The present invention provides an apparatus and a method that judge whether contents recording processing is in progress and make it possible to execute reproduction processing under accurate control. A recording control process for executing contents recording processing generates reproduction synchronization management information having a reproduction synchronization management information name, which is uniquely decided from a reproduction management information name of reproduction management information, and stores the reproduction synchronization management information in a directory that is automatically erased at the time of system startup or a volatile memory that is erased at the time of power off. A reproduction control process extracts reproduction synchronization management information on the basis of a reproduction management information name and judges whether contents to be reproduced are being recorded to execute control of a reproduction process. At the time of restart after power supply interruption, the reproduction synchronization management information is reset, and the reproduction control process is prevented from performing control misunderstanding that contents are being recorded simultaneously.

### TECHNICAL FIELD

The present invention relates to an apparatus, a method, and a computer program for information recording and reproduction processing. More specifically, the invention relates to an apparatus, a method, and a computer program that makes it possible to execute contents recording processing for videos, voices, and the like with respect to data recording means such as a hard disk and contents reproduction processing from the data recording means under accurate control without misrecognizing one of the processing states.

### BACKGROUND ART

In recent years, large capacity data storage units such as a hard disk and an optical disk have been widely used. The large capacity data storage units have been popularly used in a form of recording contents received via, for example, a broadcasting station or a satellite in these storage units and reproducing the recorded contents from the large capacity data storage units such as a hard disk and an optical disk. In particular, a large capacity hard disk has become inexpensive, and the spread of a hard disk recorder has been accelerated in place of a conventional videotape recorder. The hard disk recorder has an advantage, which the conventional videotape recorder does not have, in that random access, edition and processing of data, and the like can be performed easily. It is expected that the hard disk recorder will be spread more rapidly.

In the case in which moving image data or the like is stored in a recording medium such as a hard disk, or an optical disk, it is a general practice to store the data with an amount of data reduced by encode (compression) processing. In addition, in many cases, data transmitted via a network such as the Internet is also sent with an amount of data reduced by encode (compression) processing, the coded data is stored in a storage medium on a reception side, and decoding (expansion) processing is executed at the time of reproduction.

As a most well-known method for image compression processing, there is the MPEG (Moving Pictures Experts Group) compression technique. An MPEG stream generated by this MPEG compression is stored in a storage medium such as a hard disk or a DVD or stored in an IP packet in accordance with the IP (Internet Protocol) to be transferred on the Internet, whereby data transfer efficiency and data storage efficiency are improved.

The MPEG is a technique for realizing high grade image compression processing. A compression method of the MPEG2, which is used most frequently at present, is a compression method that is a combination of the discrete cosine transform (DCT), which is compression utilizing intra-screen correlation, movement compensation as compression based upon inter-screen correlation, and the Huffman coding as compression based upon correlation of code strings. In order to perform prediction coding using the movement compensation, the MPEG2 has a GOP (Group of Pictures) structure that is a group consisting of plural frames according to three elements called I picture, P picture, and B picture.

In the case in which frame data consisting of such a group is reproduced, decode processing by a unit of group data, that is, GOP is necessary. Compressed data recorded in a disk or the like is not always sectioned in a segment by a unit of GOP to be recorded but is stored so as to be sectionable by a unit of GOP according to Meta information including information making it possible to distinguish a storage position of contents and read out the contents. At the time of reproduction involving decoding, decoding by a unit of segment is executed, and then reproduction processing is performed.

A hard disk recorder equipped with a tuner unit, which is capable of receiving a ground wave, satellite broadcasting, or the like, records data received via the tuner in a data storage unit such as a hard disk. Digital data, which is received via a ground wave, satellite broadcasting, or the like, has generally been subjected to compression processing of the above-mentioned MPEG system or the like. Therefore, in the case in which a digital video signal supplied from these sources is recorded in the hard disk or the like, processing for recording a compressed video signal directly in the hard disk or the like is performed.

In the case in which an analog signal is received and recorded in the data storage unit such as a hard disk, processing for converting the analog signal into digital signal by A/D conversion and, thereafter, executing encode (compression) processing to record the signal in the hard disk or the like is performed.

Conventional processing of a hard disk recorder for recording and reproducing an MPEG stream will be explained with reference to FIG. 1.

First, processing at the time of data recording will be explained. An RF signal received by an antenna is supplied to a tuner a 101 and a tuner b 102. The tuner a 101 is a tuner for digital signal, and the tuner b 102 is a tuner for analog signal.

A transport stream (TS) obtained as a result of subjecting the signal to tuning, detection, and demodulation in the tuner for digital signal, the tuner a 101, is inputted to a demultiplexer (DEMUX) 110 after being descrambled passing through a descrambler 104. Note that the transport stream (TS) is a format of an MPEG stream on the IEEE1394.

On the other hand, for the signal subjected to tuning, detection, and demodulation in the tuner for analog signal, the tuner b 102, decode processing for a video signal of the NTSC system and digital conversion processing for an audio signal are executed in an NTSC decoder/audio A/D 105, and MPEG encode processing is executed in an MPEG encoder 106. Then, the signal is inputted to the demultiplexer (DEMUX) 110.

Moreover, for an input signal from an external input 103 that performs data input from another source to which, for example, another video equipment or the like is connected, decode processing for a video signal of the NTSC system and digital conversion processing for an audio signal are executed in the NTSC decoder/audio A/D 105, and MPEG encode processing is executed in the MPEG encoder 106. Then, the signal is inputted to the demultiplexer (DEMUX) 110.

The TS signal inputted to the demultiplexer (DEMUX) 110 through the descrambler 104 is separated into video PES (Packetized Elementary Stream) data as desired packetized stream data, or ES (Elementary Stream) data as elementary stream data, which is not multiplexed, and similar audio PES data or ES data corresponding to voices (audio), as well as section data as management data including tuning operation and additional information data, and the like by PID (packet identification) serving as a packet identifier to be set by a CPU 130 (host CPU).

The video PES data or the video ES data is inputted to a video decoder 111 in a later stage, the audio PES data or the audio ES data is sent to an audio decoder 112 in a later stage, and the section data is sent to a memory 113 in a later stage.

In addition, the video PES data or the audio PES data is recorded in a recording medium (hard disk) 123 through an information detection device 120 and a scrambler 121. The information detection device 120 detects reproduction procedure information and reproduction management information concerning video/voice data (contents) and records these reproduction procedure information and reproduction management information in the recording medium (hard disk) 123. The scrambler 121 executes scramble processing with respect to video data or the like and records the data subjected to the scramble processing in the recording medium (hard disk) 123.

The video decoder 111 decodes the video PES data or the ES data supplied from the demultiplexer 110 and outputs a video signal to a video display device 114 in a later stage. Then, video reproduction is executed. The audio decoder 112 decodes the audio PES data or the ES data supplied from the demultiplexer 110 and outputs a voice signal to a voice output device 115 in a later stage. Then, voice reproduction is executed.

The section data including the tuning operation and additional information is stored in the memory 113. These data are read out by the host CPU 130, processed by software, and used for various processing such as tuning processing. A memory 142 is used as a work area for the host CPU 130, a storage area for software, and the like.

Note that, the structure shown in FIG. 1 has a constitution for executing reading of user information (information on rights) which is stored in an IC card 141 owned by a user, via a card interface (I/F) 140 in order to realize a limited reception system that allows the user having a right to view to perform limited contents reproduction. The host CPU 130 executes control on the basis of the user information (information on rights) stored in the IC card 141 such that the user can view contents of the limited reception.

In the reproduction management information, link information to reproduction procedure information, in which reproduction procedures for video/voice data to be reproduced are written, and control information are managed. In the reproduction procedure information, stream data, stream management information, and contents information are managed.

Next, processing for reproducing the video/voice data (contents) recorded in the recording medium (hard disk) 123 will be explained.

The reproduction management information and the reproduction procedure information, which manage the video/voice data (contents) recorded in the recording medium (hard disk) 123, are read out from the recording medium (hard disk). The read-out video/voice data is subjected to descramble processing by the descrambler 122, and then video and audio data is inputted to the video decoder 111 and the audio decoder 112. In the video decoder 111 and the audio decoder 112, after the decode processing is executed, a video signal is outputted to the video display device 114 in the later stage, and a voice signal is outputted to the voice output device 115 in the later stage. Then, contents reproduction is executed.

Next, concerning simultaneous recording and reproduction control processing for executing the contents recording processing with respect to the recording medium (hard disk) 123 and the contents reproduction processing from the recording medium (hard disk) 123 in parallel, conventional two process configuration examples will be explained with reference to FIGS. 2 and 3.

First, a first process configuration example will be explained with reference to FIG. 2. In FIG. 2, a part above a line AA′ indicates processing according to control of software, and a part below the line AA′ indicates processing by hardware.

On a software side, there is an upper layer process (application) 204 as a recording and reproduction processing program for identifying a command and the like from a user and executing overall control for recording or reproduction. The upper layer process 204 performs supervisory control such as setting a lower process on the basis of an input or the like of the user.

In the case in which the simultaneous recording and reproduction control is executed, a simultaneous recording and reproduction control process (processing program) 203 is set under the management of the upper layer process (application program) 204, and a recording control process 201 for executing recording control and a reproduction control process 202 for executing reproduction control are set below the simultaneous recording and reproduction control process 203. Then, processing is controlled by the respective set processes.

On a hardware side, there are recording unit hardware 210 that is constituted by hardware or the like for executing, for example, descramble, scramble, MPEG decode, and encode processing, A/D conversion, or the like, reproduction unit hardware 111 that executes descramble and MPEG decode processing or the like, and a recording medium (hard disk) 212 serving as a recording medium for contents.

In this processing example, the recording control process 201 executes processing for recording contents in the recording medium (hard disk) 212 and generating reproduction management information 205 and reproduction procedure information 206. On the other hand, the reproduction control process 202 executes processing for reading out the contents from the recording medium (hard disk) 212 and sending the contents to the reproduction unit hardware 211 in accordance with the reproduction management information 205 or the like.

However, in this processing method, the recording control process (processing program) 201 and the reproduction control process (processing program) 202 are set individually by a unit of recording processing and by a unit of reproduction processing. Thus, there is a problem in that, in the case in which the number of contents to be recorded simultaneously increases or the number of contents to be reproduced simultaneously increases, it becomes necessary to increase the recording control process 201 and the reproduction control process 202 according to the increased number of contents and, in addition, it becomes necessary to reset the process (processing program) 203 for controlling simultaneous recording and reproduction.

Moreover, a second process configuration example will be explained with reference to FIG. 3. In FIG. 3, as in FIG. 2, a part above a line AA′ indicates processing according to control of software and a part below the line AA′ indicates processing by hardware.

In this example, simultaneous reproduction control for contents being recorded is constituted by a recording control process 301 for recording contents in a recording medium (hard disk) 312 and generating reproduction management information 304 and reproduction procedure information 305, a reproduction control process 302 for reading out the contents from the recording medium (hard disk) 312 and sending the contents to reproduction unit hardware 311 in accordance with the reproduction management information 304 or the like, and an upper layer process 303 for not performing direct control for recording and reproduction. The recording control process 301 has means for managing reproduction synchronization management information in the reproduction management information 304, and the reproduction control process 302 judges whether contents being reproduced is being recorded or has been recorded with reference to the reproduction synchronization management information in the reproduction management information 304 and performs reproduction control according to the judgment.

However, in this method, in the even that interruption of a power supply such as power supply cutoff or service interruption occurs during a recording operation, the reproduction synchronization management information in the reproduction management information 304 is maintained while still indicating that the contents is being recorded. As a result, in the case in which restart is performed to start contents reproduction after power supply interruption, the reproduction control process 302 judges that the contents are being recorded on the basis of the reproduction synchronization management information in the reproduction management information 304.

Therefore, even if a reproduction operation has reached a recording endpoint in the reproduction management information 304, the reproduction control process 302 executes processing for waiting for recording of the contents to further progress and the recording end point in the reproduction management information 304 to be updated. However, since the contents recording processing is not executed actually, as a result, the processing stops. This causes a problem in that the reproduction control process 302 cannot shift to ending processing that is necessary in the case in which reproduction control for recorded contents is performed.

As a conventional technique disclosing a technique for performing reproduction processing for video data, which is being recorded, simultaneously with recording of video, for example, there is a patent document 1: JP-A-2001-297519. This patent document 1 discloses a constitution concerning time-shift reproduction that makes it possible to reproduce video data from an arbitrary position. The patent document 1 discloses a constitution for, for example, in the even that a reproduction unit has caught up with a recording unit due to high-speed reproduction or the like, executing simultaneous recording and reproduction without an error according to, for example, processing for pausing reproduction and resuming the reproduction after a fixed time.

However, the patent document 1 does not disclose a constitution for solving the problem of process setting in the case in which the number of contents to be recorded simultaneously increases or the number of contents to be reproduced simultaneously increases and the problem in that, at the time of power supply cut off or the like, reproduction synchronization management information in reproduction management information is maintained while still indicating that contents are being recorded, and a reproduction process side cannot shift to ending processing.

### DISCLOSURE OF THE INVENTION

The present invention has been devised in view of the above-mentioned problems, and it is an object of the invention to provide an apparatus, a method, and a computer program for information recording and reproduction processing that, in the case in which the number of contents to be recorded simultaneously increases or the number of contents to be reproduced simultaneously increases, makes it possible to execute contents recording processing and contents reproduction processing without making a significant change in a setting process and solves the problem in that, at the time of power supply cutoff, reproduction synchronization management information in reproduction management information is maintained while still indicating that contents are being recorded, and a reproduction process side cannot shift to ending processing.

A first aspect of the invention is an information recording and reproduction processing apparatus that executes data recording and reproduction processing, characterized by including:

storing means for data recording;

a recording control process execution unit that generates reproduction management information including at least data recording end position information and executes data recording control for the storing means; and

a reproduction control process execution unit that executes reproduction control processing for data, which is readout from the storing means, on the basis of the reproduction management information, and in that

the recording control process execution unit has a constitution for, in the case of data recording processing, generating reproduction synchronization management information indicating that recording processing for data is in progress, associating the reproduction synchronization management information with the reproduction management information, and executing processing for recording the generated reproduction synchronization management information in a directory that is automatically erased at the time of system startup or at the time of system shutdown, and

the reproduction control process execution unit is constituted to, in the case of data reproduction processing, extract reproduction management information corresponding to reproduction data, execute retrieval processing for reproduction synchronization management information based upon the reproduction management information, judge whether data is being recorded on the basis of presence or absence of reproduction synchronization management information, and execute data reproduction control according to a result of the judgment.

In one mode of the information recording and reproduction processing apparatus of the invention, the information recording and reproduction processing apparatus is characterized in that the recording control process execution unit is constituted to execute processing for storing the reproduction synchronization management information in a volatile memory.

In one mode of the information recording and reproduction processing apparatus of the invention, the information recording and reproduction processing apparatus is characterized in that the recording control process execution unit is constituted to execute processing for setting a reproduction synchronization management information name, which is set in the reproduction synchronization management information, as a file name that can be identified uniquely from the reproduction management information name, and the reproduction control process execution unit is constituted to specify a reproduction synchronization management information name on the basis of the reproduction management information name and execute retrieval processing for reproduction synchronization management information on the basis of the reproduction synchronization management information name.

In one mode of the information recording and reproduction processing apparatus of the invention, the information recording and reproduction processing apparatus is characterized in that the information recording and reproduction processing apparatus has an upper layer process execution unit that executes setting processing for the recording control process, the recording control process execution unit is constituted to generate an identifier (ID) with which the reproduction management information can be identified uniquely and output the generated identifier to an upper process execution unit, the upper layer process execution unit is constituted to execute processing for storing the identifier (ID) in a storage unit and managing the identifier, and the reproduction control process execution unit is constituted to execute processing for inputting the identifier (ID) from the upper process execution unit and acquiring the reproduction management information on the basis of the identifier (ID).

In one mode of the information recording and reproduction processing apparatus of the invention, the information recording and reproduction processing apparatus is characterized in that the recording control process execution unit is constituted to execute recording of data to be an object of reproduction processing with respect to the storing means constituted by a nonvolatile memory and execute processing for storing the reproduction synchronization management information in a volatile memory different from the storing means.

In one mode of the information recording and reproduction processing apparatus of the invention, the information recording and reproduction processing apparatus is characterized in that the reproduction control processing execution unit is constituted to, in the case in which reproduction synchronization management information is detected, judge that data recording processing is in progress, execute control for reproduction processing while confirming an update state of a recording end point in reproduction management information, and, in the case in which a reproduction position reaches the recording end point in the reproduction management information, perform reproduction suspension processing.

In one mode of the information recording and reproduction processing apparatus of the invention, the information recording and reproduction processing apparatus is characterized in that the reproduction control process execution unit is constituted to, in the case in which reproduction synchronization management information is not detected, judge that data recording processing is not in progress, execute reproduction control for data as recorded data, and, in the case in which a reproduction position reaches a recording end point in reproduction management information, execute control for shifting to reproduction ending processing.

In one mode of the information recording and reproduction processing apparatus of the invention, the information recording and reproduction processing apparatus is characterized in that the reproduction control process execution unit is constituted to, in the case in which reproduction synchronization management information is detected, periodically verify presence or absence of the reproduction synchronization management information, in the case in which the reproduction synchronization management information is erased, execute reproduction control for data as recorded data, and, in the case in which a reproduction position reaches a recording end point in reproduction management information, execute control for shifting to reproduction ending processing.

A second aspect of the invention is an information recording and reproduction processing apparatus that executes data recording and reproduction processing, characterized by including:

storing means for data recording;

a recording control process execution unit that generates reproduction management information including at least data recording end position information and executes data recording control for the storing means; and

a reproduction control process execution unit that executes reproduction control processing for data, which is read out from the storing means, on the basis of the reproduction management information, and in that

the recording control process execution unit has a constitution for, in the case of data recording processing, executing processing for generating reproduction synchronization management information indicating that recording processing for data is in progress and recording management information having link information of the reproduction synchronization management information and storing the generated reproduction synchronization management information and recording management information in storing means, and

executing retrieval processing for recording management information at the time of system startup, extracting and erasing reproduction synchronization management information on the basis of link information of extracted recording management information, and executing erasing processing for the extracted recording management information, and

the reproduction control process execution unit is constituted to, in the case of data reproduction processing, extract reproduction management information corresponding to reproduction data, execute retrieval processing for reproduction synchronization management information based upon the reproduction management information, judge whether data is being recorded on the basis of presence or absence of reproduction synchronization management information, and execute data reproduction control according to a result of the judgment.

In one mode of the information recording and reproduction processing apparatus of the invention, the information recording and reproduction processing apparatus is characterized in that the recording control process execution unit is constituted to execute recording of data to be an object of reproduction processing and recording of the reproduction synchronization management information and recording management information with respect to the storing means constituted by a nonvolatile memory.

In one mode of the information recording and reproduction processing apparatus of the invention, the information recording and reproduction processing apparatus is characterized in that the recording control process execution unit is constituted to execute processing for setting a reproduction synchronization management information name, which is set in the reproduction synchronization management information, as a file name that can be identified uniquely from the reproduction management information name, and the reproduction control process execution unit is constituted to specify a reproduction synchronization management information name on the basis of the reproduction management information name and execute retrieval processing for reproduction synchronization management information on the basis of the reproduction synchronization management information name.

In one mode of the information recording and reproduction processing apparatus of the invention, the information recording and reproduction processing apparatus is characterized in that the information recording and reproduction processing apparatus has an upper layer process execution unit that executes setting processing for the recording control process, the recording control process execution unit is constituted to generate an identifier (ID) with which the reproduction management information can be identified uniquely and output the generated identifier to an upper process execution unit, the upper layer process execution unit is constituted to execute processing for storing the identifier (ID) in a storage unit and managing the identifier, and the reproduction control process execution unit is constituted to execute processing for inputting the identifier (ID) from the upper process execution unit and acquiring the reproduction management information on the basis of the identifier (ID).

In one mode of the information recording and reproduction processing apparatus of the invention, the information recording and reproduction processing apparatus is characterized in that the reproduction control processing execution unit is constituted to, in the case in which reproduction synchronization management information is detected, judge that data recording processing is in progress, execute control for reproduction processing while confirming an update state of a recording end point in reproduction management information, and, in the case in which a reproduction position reaches the recording end point in the reproduction management information, perform reproduction suspension processing.

In one mode of the information recording and reproduction processing apparatus of the invention, the information recording and reproduction processing apparatus is characterized in that the reproduction control process execution unit is constituted to, in the case in which reproduction synchronization management information is not detected, judge that data recording processing is not in progress, execute reproduction control for data as recorded data, and, in the case in which a reproduction position reaches a recording end point in reproduction management information, execute control for shifting to reproduction ending processing.

In one mode of the information recording and reproduction processing apparatus of the invention, the information recording and reproduction processing apparatus is characterized in that the reproduction control process execution unit is constituted to, in the case in which reproduction synchronization management information is detected, periodically verify presence or absence of the reproduction synchronization management information, in the case in which the reproduction synchronization management information is erased, execute reproduction control for data as recorded data, and, in the case in which a reproduction position reaches a recording end point in reproduction management information, execute control for shifting to reproduction ending processing.

A third aspect of the invention is an information recording processing method for executing data recording processing, characterized by including:

a reproduction synchronization management information generation step of, in the case of data recording processing, generating reproduction synchronization management information indicating that recording processing for data is in progress;

an association processing step of associating the reproduction synchronization management information to the reproduction management information; and

a reproduction synchronization management information recording step of executing processing for recording the reproduction synchronization management information in a directory that is automatically erased at the time of system startup or at the time of system shutdown.

In one mode of the information recording processing method of the invention, the information recording processing method is characterized in that the reproduction synchronization management information recording step is a step of executing processing for storing the reproduction synchronization management information in a volatile memory.

In one mode of the information recording processing method of the invention, the information recording processing method is characterized in that the association processing step is a step of executing processing for setting a reproduction synchronization management information name, which is set in the reproduction synchronization management information, as a file name that can be identified uniquely from the reproduction management information name.

In one mode of the information recording processing method of the invention, the information recording processing method is characterized in that the information recording processing method further includes: a step of generating an identifier (ID) with which the reproduction management information can be identified uniquely and outputting the generated identifier to an upper process execution unit; and a step of storing the identifier (ID) in a storing unit and managing the identifier in the upper layer process execution unit.

A fourth aspect of the invention is an information recording processing method for executing data recording processing, characterized by including:

a management information generation step of, in the case of data recording processing, generating reproduction synchronization management information indicating that recording processing for data is in progress and recording management information having link information of the reproduction synchronization management information;

a management information recording processing step of storing the generated reproduction synchronization management information and recording management information in storing means; and

a management information erasing step of, at the time of system start up, executing retrieval processing for recording management information, extracting and erasing reproduction synchronization management information on the basis of link information of extracted recording management information, and executing erasing processing for the extracted recording management information.

In one mode of the information recording processing method of the invention, the information recording processing method is characterized in that the management information recording processing step executes recording of data to be an object of reproduction processing and recording of the reproduction synchronization management information and recording management information with respect to the storing means constituted by a nonvolatile memory.

In one mode of the information recording processing method of the invention, the information recording processing method is characterized in that the information recording processing method further includes: a step of generating an identifier (ID) with which the reproduction management information can be identified uniquely and outputting the generated identifier to an upper process execution unit; and a step of storing the identifier (ID) in a storing unit and managing the identifier in the upper layer process execution unit.

A fifth aspect of the invention is an information reproduction processing method for executing data reproduction processing, characterized by including:

a reproduction management information extraction step of, in the case of data reproduction processing, extracting reproduction management information corresponding to reproduction data;

a reproduction synchronization management information retrieval step of executing retrieval processing for reproduction synchronization management information that can be identified uniquely from extracted reproduction management information; and

a reproduction control step of executing reproduction control for data being recorded or reproduction control processing for data not being recorded on the basis of presence or absence of the reproduction synchronization management information.

In one mode of the information reproduction processing method of the invention, the information reproduction processing method is characterized in that a reproduction synchronization management information name set in the reproduction synchronization management information is a file name that can be identified uniquely from the reproduction management information name, and the reproduction synchronization management information retrieval step is a step of specifying a reproduction synchronization management information name on the basis of the reproduction management information name and executing retrieval processing for reproduction synchronization management information on the basis of the reproduction synchronization management information name.

In one mode of the information reproduction processing method of the invention, the information reproduction processing method is characterized in that the reproduction control step is a step of, in the case in which reproduction synchronization management information is present, judging that data recording processing is in progress and executing control for reproduction processing while confirming an update state of a recording end point in reproduction management information, and, in the case in which a reproduction position reaches the recording end point in the reproduction management information, executing control processing for performing suspension processing.

In one mode of the information reproduction processing method of the invention,the information reproduction processing method is characterized in that the reproduction control step is a step of, in the case in which reproduction synchronization management information is not present, judging that data recording processing is in progress and executing reproduction control for data as recorded data, and, in the case in which a reproduction position reaches a recording end point in reproduction management information, executing control for shifting to reproduction ending processing.

In one mode of the information reproduction processing method of the invention, the information reproduction processing method is characterized in that the information reproduction processing method further includes: a step of, in the case in which reproduction synchronization management information is present, periodically verifying presence or absence of reproduction synchronization management information, in the case in which the reproduction synchronization management information is erased, executing reproduction control for data as recorded data, and, in the case in which are production position reaches a recording end point in reproduction management information, executing control for shifting to reproduction end processing.

In one mode of the information reproduction processing method of the invention, the information reproduction processing method is characterized in that the reproduction management information extraction step is a step of inputting an identifier (ID), with which the reproduction management information can be identified uniquely, from an upper process execution unit and executing processing for acquiring the reproduction management information on the basis of the identifier (ID).

A sixth aspect of the invention is a computer program for executing data recording processing, characterized by including:

a reproduction synchronization management information generation step of, in the case of data recording processing, generating reproduction synchronization management information indicating that recording processing for data is in progress;

an association processing step of associating the reproduction synchronization management information to the reproduction management information; and

a reproduction synchronization management information recording step of executing processing for recording the reproduction synchronization management information in a directory that is automatically erased at the time of system startup or at the time of system shutdown.

A seventh aspect of the invention is a computer program for executing data recording processing, characterized by including:

a management information generation step of, in the case of data recording processing, generating reproduction synchronization management information indicating that recording processing for data is in progress and recording management information having link information of the reproduction synchronization management information;

a management information recording processing step of storing the generated reproduction synchronization management information and recording management information in storing means; and

a management information erasing step of, at the time of system start up, executing retrieval processing for recording management information, extracting and erasing reproduction synchronization management information on the basis of link information of extracted recording management information, and executing erasing processing for the extracted recording management information.

An eighth aspect of the invention is a computer program for executing data reproduction processing, characterized by including:

a reproduction management information extraction step of, in the case of data reproduction processing, extracting reproduction management information corresponding to reproduction data;

a reproduction synchronization management information retrieval step of executing retrieval processing for reproduction synchronization management information that can be identified uniquely from extracted reproduction management information; and

a reproduction control step of executing reproduction control for data being recorded or reproduction control processing for data not being recorded.

According to the constitution of the invention, the recording control process for executing contents recording processing generates reproduction synchronization management information having a reproduction synchronization management information name that is uniquely decided from a reproduction management information name of recording data, and the reproduction control process extracts reproduction synchronization management information on the basis of a reproduction management information name and judges whether contents to be reproduced are being recorded to execute control of a reproduction process. Thus, even if the number of contents to be recorded simultaneously increases or the number of contents to be reproduced simultaneously increases, it is possible to cope with both a reproduction operation for contents being recorded and a reproduction operation for recorded contents simply by increasing the recording control process and the reproduction control process according to the increased number of contents, respectively.

According to the constitution of the invention, the recording control process outputs an identifier (ID), with which reproduction management information can be identified, to an upper layer process. The reproduction control process becomes capable of acquiring reproduction management information on the basis of the identifier (ID), with which reproduction management information can be identified, and extracting reproduction synchronization management information on the basis of a reproduction management information name of the acquired reproduction management information, and judging whether contents to be reproduced are being recorded to execute control for a reproduction process.

According to the constitution of the invention, reproduction synchronization management information is stored in a directory that is automatically erased at the time of system startup or a volatile memory that is erased at the time of power off. Thus, even in the case in which a recording control process, which has generated reproduction synchronization management information, stops during execution due to power supply interruption or the like, the reproduction synchronization management information is reset after restart. Therefore, since data indicating that contents are being recorded does not remain as in the conventional constitution, the reproduction control process is prevented from performing reproduction control misunderstanding that the contents are contents being simultaneously recorded.

According to the constitution of the invention, erasing of reproduction synchronization management information and erasing processing for recording management information having link information of the reproduction synchronization management information are executed by the recording control process at the time of system startup. Thus, it becomes possible to store reproduction synchronization management information in a recording medium such as a hard disk without setting the reproduction synchronization management information to be automatically erased due to power supply interruption such as service interruption, and occurrence of wrong control according to the reproduction control process is prevented.

Note that the computer program of the invention is a computer program that can be provided to, for example, a general-purpose computer system capable of executing various program codes by a storage medium or a communication medium to be provided in a computer readable format, for example, a storage medium such as a CD, an FD, or an MO or a communication medium such as a network. By providing such programs in a computer readable format, processing according to the programs is realized on a computer system.

Other objects, characteristics, and advantages of the invention will be apparent from more detailed explanation based upon embodiments of the invention to be described later and attached drawings. Note that, in this specification, a system is a logical set constitution of plural apparatuses and is not limited to a system in which apparatuses of respective constitutions are provided in an identical housing.

### BRIEF DESCRIPTION OF THE DRAWINGS

FIG. 1 is a diagram showing a structure of a hard disk recorder that records and reproduces an MPEG stream.

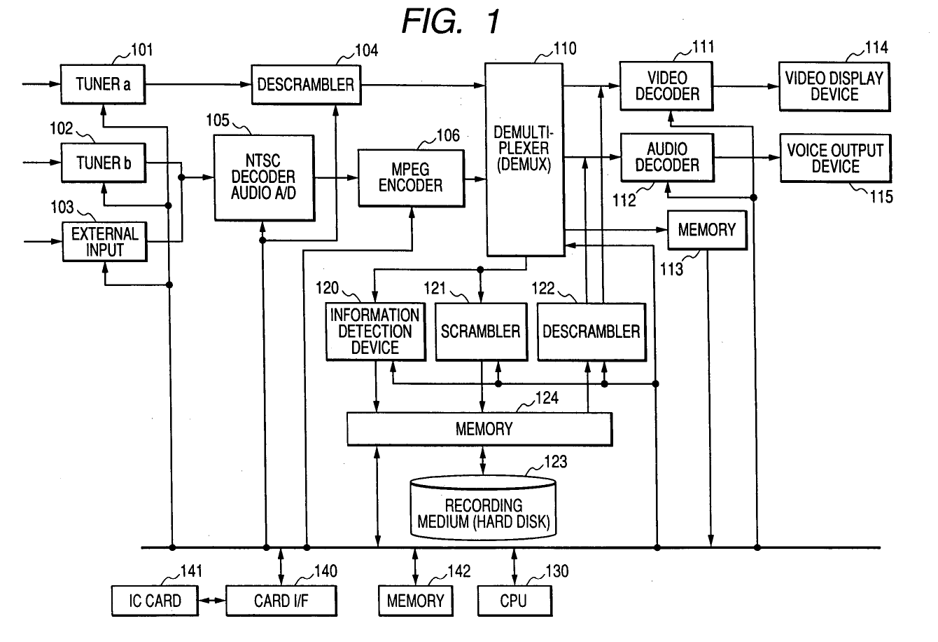

FIG. 2 is a diagram illustrating a process configuration example (example 1) in simultaneous recording and reproduction control processing for executing contents recording processing with respect to a recording medium and contents reproduction processing from the recording medium in parallel.

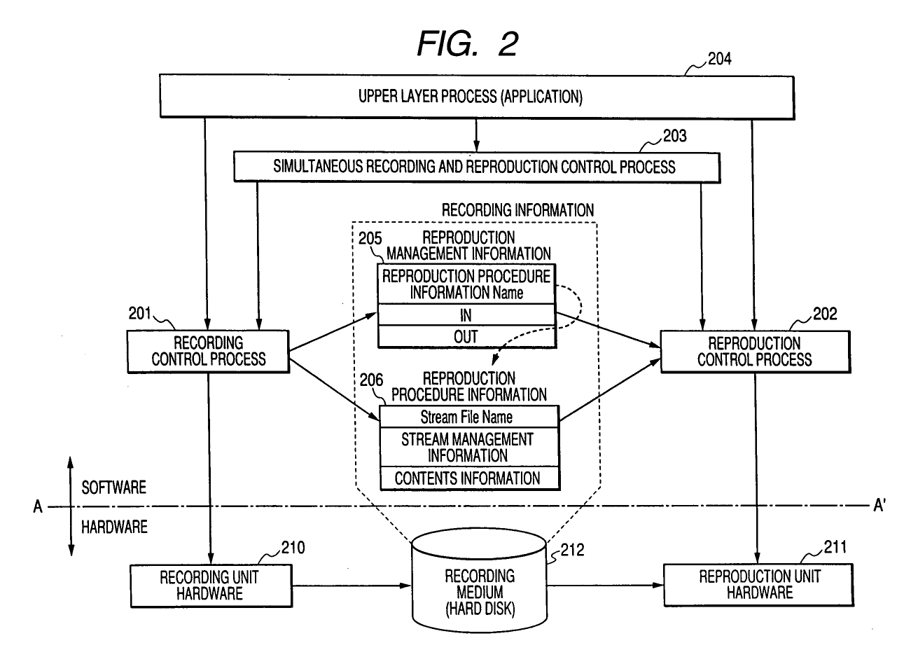

FIG. 3 is a diagram illustrating a process configuration example (example 1) in simultaneous recording and reproduction control processing for executing contents recording processing with respect to a recording medium and contents reproduction processing from the recording medium in parallel.

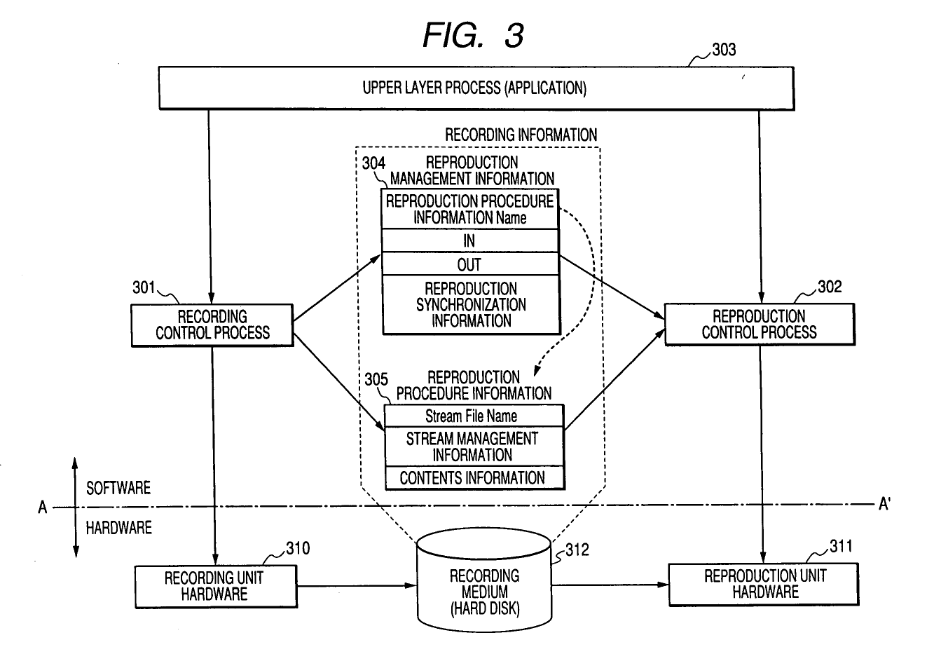

FIG. 4 is a diagram illustrating a process configuration example (first embodiment) in contents simultaneous recording and reproduction control processing of the invention.

FIG. 5 is a diagram showing a hardware configuration example for executing the contents simultaneous recording and reproduction control processing of the invention.

FIG. 6 is a flowchart explaining a processing procedure of a recording control process in the contents simultaneous recording and reproduction control processing of the invention.

FIG. 7 is a flowchart explaining a processing procedure of a reproduction control process in the contents simultaneous recording and reproduction control processing of the invention.

FIG. 8 is a diagram illustrating a process configuration example (second embodiment) in the contents simultaneous recording and reproduction control processing of the invention.

FIG. 9 is a flowchart explaining a processing procedure of the recording control process in the contents simultaneous recording and reproduction control processing of the invention.

FIG. 10 is a flowchart explaining a processing procedure at the time of system startup of the recording control process in the contents simultaneous recording and reproduction control processing of the invention.

### BEST MODE FOR CARRYING OUT THE INVENTION

Details of an apparatus, a method, and a computer program for information recording and reproduction processing of the invention will be hereinafter explained with reference to the drawings.

### First Embodiment

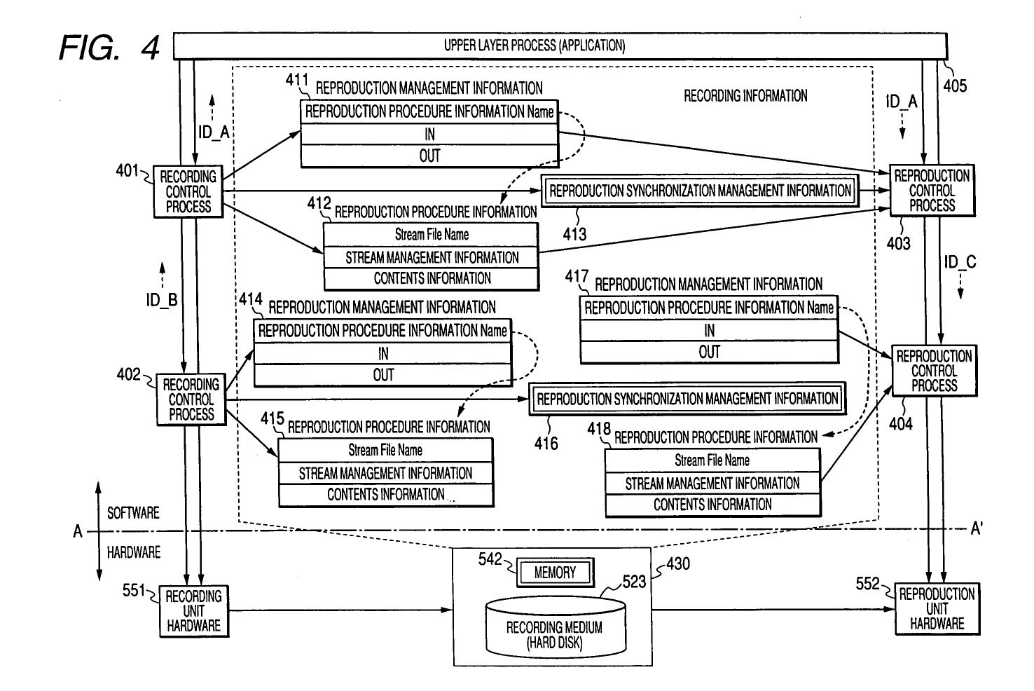

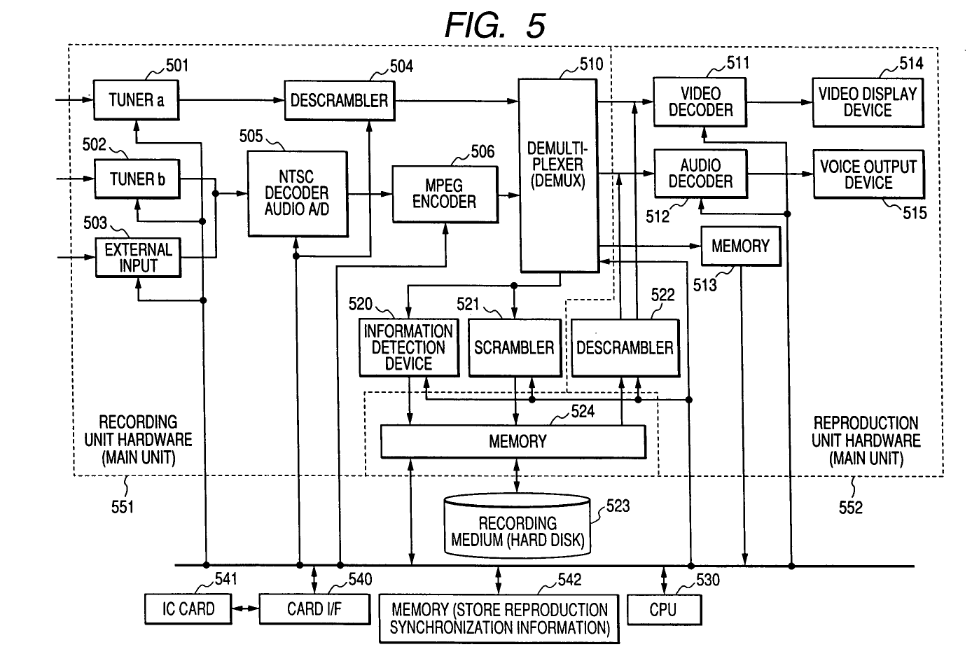

FIG. 4 shows a process configuration in contents simultaneous recording and reproduction control processing in accordance with a first embodiment of an information recording and reproduction processing apparatus of the invention, and FIG. 5 shows a hardware configuration of the information recording and reproduction processing apparatus.

In FIG. 4, a part above a line AA′ indicates processes, which are set in processing according to control of software, and recording information to be applied in the processes, and a part below the line AA′ indicates a hardware part configuration. A processing program according to software control in the upper part of FIG. 4 is stored in a memory 542 or a hard disk 523 of the hardware configuration shown in FIG. 5 and is read out to a CPU 530 and executed.

On the software side, there is an upper layer process (application) 405 serving as a recording and reproduction processing program that identifies a command and the like from a user and executes overall control of recording or reproduction. In the case in which simultaneous recording and reproduction control is executed, under management of the upper layer process (application program) 405, recording control processes 401, 402, . . . , which execute recording control, or reproduction control processes 403 and 404, which execute reproduction control, are set every time new recording processing or new reproduction processing occurs, for example by a unit of contents, and processing is controlled by the respective set processes. Note that, although the two recording control process and the two reproduction control processes are shown in FIG. 4, these processes increase or decrease according to an increase or a decrease in execution processes.

The CPU 530 executes the respective processes shown in FIG. 4 as a process execution unit in terms of hardware. In other words, the respective process execution programs are developed in the memory 542, and the CPU 530 executes the respective processes. Therefore, the CPU 530 functions as respective execution units for the upper layer process (application), the recording control process, and the reproduction control process shown in FIG. 4.

On the hardware side below AA′ shown in FIG. 4, other than the CPU as the process execution unit, there are recording unit hardware 551 that is constituted by hardware or the like, which executes, for example, descramble, scramble, MPEG decode, encode processing, or A/D conversion, reproduction unit hardware 552 that executes descramble, MPEG decode processing, and the like, and a storage unit 430 that consists of a recording medium (hard disk) 523 serving as a recording medium for contents and a volatile memory 542 in which recording data is cleared (erased) by power off.

Note that association of the recording unit hardware 551, the reproduction unit hardware 552, the recording medium (hard disk) 523, and the volatile memory 542 is shown in a hardware configuration diagram of FIG. 5.

The recording unit hardware 551 includes a tuner a 501 that is a tuner for digital signal, a tuner b 502 that is a tuner for analog signal, an external input 503 to which another video apparatus or the like is connected, a descrambler 504 that executes descramble processing, an NTSC decoder/audio A/D 505 that executes decode processing for a video signal of the NTSC system and digital conversion processing for an audio signal, and an MPEG encoder 506 that executes MPEG encode processing.

Moreover, the recording unit hardware 551 includes a demultiplexer (DEMUX) 510 that executes processing for separating data into video PES (Packetized Elementary Stream) data as desired packetized stream data, or ES (Elementary Stream) data as elementary stream data, which is not multiplexed, and similar audio PES data or ES data corresponding to voices (audio), as well as section data as management data including tuning operation and additional information data, and the like with PID (packet identification) serving as a packet identifier, an information detection device 520 that executes processing for detecting reproduction procedure information and reproduction management information concerning video/voice data (contents), and a scrambler 521 that executes scramble processing with respect to video data or the like to be recorded in the recording medium (hard disk) 523.

On the other hand, the reproduction unit hardware 552 includes a descrambler 522 that executes descrambling of data read out from the recording medium (hard disk) 523, a video decoder 511 and an audio decoder 512 that execute decode processing for video compression data and audio compression data, and a video display device 514 and a voice output device 515 that output decode data. Moreover, the reproduction unit hardware 552 includes a memory 513 that stores section data including tuning operation and additional information data. These data are read out by the host CPU 530, processed by software, and used for a desired operation.

A memory 524 is an area that is used as a temporary buffer area for data to be written in the recording medium (hard disk) 523 or data to be read from the recording medium (hard disk) 523 and is included in both the recording unit hardware 551 and the reproduction unit hardware 552. The CPU 530 serving as a process execution unit and the memory 524, which is used as a program storage area and a work area, are also areas included in both the recording unit hardware 551 and the reproduction unit hardware 552.

Note that the hardware configuration in FIG. 5 is constituted to execute reading of user information (information on rights) stored in an IC card 541 owned by a user via a card interface (I/F) 540 in order to realize a limited reception system that makes it possible to perform contents reproduction limited to a user having a right to view. Limitation on viewing contents of limited reception is realized by control of the host CPU 530 based upon user information read from the IC card 541. However, this view limiting constitution is not a constitution essential for the invention.

Referring back to FIG. 4, respective pieces of information to be generated or used at the time of contents recording and contents reproduction will be explained. Reproduction management information 411, 414, and 417 is information that is generated at the time of contents recording and used at the time of contents reproduction and stores management information describing an order of contents to be reproduced. More specifically, the reproduction management information 411, 414, and 417 includes name (Name) indicating corresponding reproduction procedure information, and a start point [In] and an end point [Out] of contents as time information indicating start and end points of contents.

Reproduction procedure information 412, 415, and 418 is information that is generated at the time of contents recording and used at the time of contents reproduction and stores management information for contents continuously recorded in one recording medium. More specifically, the reproduction procedure information 412, 415, and 418 includes stream management information consisting of a file name (stream file name), time information, video header information, and audio header information of video, audio, and section data and contents management information consisting of a packet ID, copy control information, and the like.

These pieces of reproduction management information 411, 414, 417 and reproduction procedure information 412, 415, 418 are stored and held in the recording medium (hard disk) 523 together with contents.

Reproduction synchronization management information 413 and 416 is information indicating that contents are being recorded and is set at the start of recording processing by the recording control processes 401 and 402. A reproduction synchronization management information name (file name) to be set in the reproduction synchronization management information 413 and 416 is set as a name, which is uniquely decided from a reproduction management information name (file name) to be set in corresponding reproduction management information such that it is possible to extract reproduction synchronization management information from the reproduction synchronization management information name.

As an association constitution of the reproduction synchronization management information name (file name) and the reproduction management information name (file name) to be set in the corresponding reproduction management information, for example, it is possible to set a common character string in a part of both the file names or, in the case in which the reproduction management information name (file name)=A, set the reproduction synchronization management information name (file name) as A+a.

Alternatively, it is also possible that link information is set in reproduction management information without depending upon association according to a file name, and reproduction synchronization management information can be extracted on the basis of the link information.

Since the reproduction synchronization management information name (file name) and the reproduction management information name (file name) are associated in this way, the reproduction control processes 403 and 404 can extract reproduction synchronization management information on the basis of reproduction management information used at the time of contents reproduction. The reproduction control processes 403 and 404 can judge whether contents to be reproduced are contents being subjected to recording processing according to whether the reproduction synchronization management information 413 and 416 is present.

This reproduction synchronization management information 413 and 416 is recorded in a directory that is automatically erased at the time of system startup or at the time of system shutdown. More specifically, for example, the reproduction synchronization management information 413 and 416 is not stored in the recording medium (hard disk) 523 but is stored in the volatile memory 542 (see FIG. 5). The memory 542 is a volatile memory, and stored data is reset (erased) simultaneously with power supply interruption.

Simultaneous recording and reproduction processing of the first embodiment will be explained with reference to FIG. 4. The recording control processes 401 and 402 shown in FIG. 4 are set under the control of an upper layer process (application) every time new recording processing occurs, for example, by a unit of contents to be recorded.

The recording control process 401 extracts time information, video management information, and audio management information from video PES data and audio PES data of video/voice data (contents) in the information detection device 520 (see FIG. 5) at the time of contents recording, records these pieces of information in the reproduction procedure information 412 in association with the contents, and performs reproduction processing of the reproduction procedure information 412.

The recording control process 401 registers the reproduction procedure information 412 in the reproduction management information 411 and executes association (link) processing for the reproduction procedure information 412 and the reproduction management information 411. As the start point [In] of contents of reproduction management information, predetermined time information is set as contents start point information in a contents recording start point. The end point [Out] of contents is time data indicating an end data position where contents have been recorded, which is updated as contents recording processing progresses.

The recording control process 401 generates the reproduction synchronization management information 413 at the time of starting recording of contents. As described above, the reproduction synchronization management information 413 indicates that a contents recording process by the recording control process 401 is being executed and is erased when the recording process ends. In addition, since the reproduction synchronization management information 413 is stored in the volatile memory 542, the reproduction synchronization management information 413 is erased in the case of power off during execution of recording processing.

A reproduction synchronization management information name (file name) to be set in the reproduction synchronization management information 413 is set as a name that is uniquely decided from a reproduction management information name (file name) to be set in a corresponding reproduction management information 111 such that reproduction synchronization management information can be extracted on the basis of a reproduction synchronization management information name to be derived from a reproduction management information name.

The recording control process 401 outputs an identifier ID_A, with which a name (file name) of the reproduction management information 411 can be identified, to the upper layer process (application) 405 that does not execute direct control concerning recording and reproduction. The upper layer process (application) 405 stores the identifier ID_A, with which the reproduction management information 411 can be identified, in a data storage area such as the hard disk 523 and manages the identifier.

The other recording control process 402 also executes the same processing as that in the recording control process 401 with respect to another recording process. At the time of contents recording, in the information detection device 520 (see FIG. 5), the recording control process 402 extracts time information, video management information, and audio management information from video PES data and audio PES data of video/voice data (contents), records these pieces of information in the reproduction procedure information 415 in association with the contents, performs generation processing for the reproduction procedure information 415, and registers the reproduction procedure information 415 in the reproduction management information 414 to execute association (link) processing.

The recording control process 402 generates the reproduction synchronization management information 416 simultaneously with start of recording of contents. The reproduction synchronization management information 416 indicates that a contents recording process by the recording control process 402 is being executed and is erased when the recording process ends. In addition, since the reproduction synchronization management information 416 is stored in the volatile memory 542, the reproduction synchronization management information 416 is also erased in the case of power off during execution of recording processing.

The recording control process 402 outputs an identifier ID_B, with which the reproduction management information 414 name (file name) can be identified, to the upper layer process (application) 405 that does not execute direct control concerning recording and reproduction. The upper layer process (application) 405 manages the identifier ID_B, with which the reproduction management information 414 can be identified.

On the other hand, a reproduction control process inputs an identifier (ID), with which a reproduction management information name can be identified, from the upper layer process 405 that does not perform control concerning recording and reproduction, specifies reproduction management information corresponding to contents to be reproduced on the basis of the identifier (ID), and reads out reproduction procedure information of contents to be reproduced with reference to the specified reproduction management information. In addition, the reproduction control process specifies a reproduction synchronization management information name from the reproduction management information name, confirms presence or absence of reproduction synchronization management information having the reproduction synchronization management information name, and judges whether the contents to be reproduced are contents being recording.

In FIG. 4, the reproduction control process 403 is a process for executing reproduction of contents for which recording processing is being executed by the recording control process 401.

When the reproduction control process 403 acquires the identifier (ID_A), with which a reproduction management information name can be identified, from the upper layer process 405 that does not perform control concerning recording and reproduction, the reproduction control process 403 specifies the reproduction management information 411 corresponding to contents to be reproduced on the basis of the acquired identifier (ID_A) and reads out the reproduction procedure information 412 of contents to be reproduced with reference to this reproduction management information 411. In addition, the reproduction control process 403 can specify a reproduction synchronization management information name from the reproduction management information name, confirm presence or absence of the reproduction synchronization management information, and judge whether the contents to be reproduced are contents being recorded.

In this example, since the reproduction synchronization management information 413 is present, it is judged that contents to be reproduced are contents for which recording is in progress.

In the case in which the reproduction synchronization management information 413 is present and it is judged that contents to be reproduced are contents being recorded in this way, in accordance with the reproduction management information 411 and the reproduction procedure information 412, the reproduction control process 403 performs reproduction control necessary for reproduction of contents being recorded simultaneously. For example, in the case in which a reproduction operation has reached a recording end point [OUT] in the reproduction management information 411, the reproduction control process 403 performs reproduction control such as executing processing for waiting until contents recording processing by the recording control process 401 proceeds and the recording end point [OUT] in the reproduction management information 411 is updated, that is, suspending (pausing) reproduction processing.

In addition, in the case in which presence of the reproduction synchronization management information 413 corresponding to contents to be reproduced is confirmed by the reproduction control process 403 in this way, the reproduction control process 403 confirms presence of the reproduction synchronization management information 413 periodically. According to completion of recording processing of contents, in the case in which the reproduction synchronization management information 413 is erased by the recording control process 401 and is not present any more, the reproduction control process 403 judges that recording of contents being reproduced has ended and shifts to reproduction control of the contents as recorded contents after that. In other words, in the case in which a reproduction operation has reached a recording end point in the reproduction management information 411, the reproduction control process 403 can perform control of shifting to reproduction end processing.

On the other hand, in FIG. 4, the reproduction control process 404 is a process for executing reproduction of contents for which recording processing by a recording control process is not executed.

The reproduction control process 404 specifies the reproduction management information 417 to be reproduced on the basis of an ID [ID_C], with which a reproduction management information name can be identified, passed from the upper layer process 405 that does not perform control concerning recording and reproduction, and reads out the reproduction procedure information 418 of contents to be reproduced with reference to this reproduction management information 417. In addition, the reproduction control process 404 specifies a reproduction synchronization management information name from the reproduction management information name and confirms presence or absence of the reproduction synchronization management information.

In this example, since a reproduction synchronization management information corresponding to the reproduction management information 417 is not present, contents to be reproduced are judged as recorded contents, the reproduction control process 404 performs reproduction control necessary for reproduction of the recorded contents in accordance with the reproduction management information 417 and the reproduction procedure information 418, for example, in the case in which a reproduction operation has reached a recording end point in the reproduction management information 417, performs control of shifting the reproduction end processing.

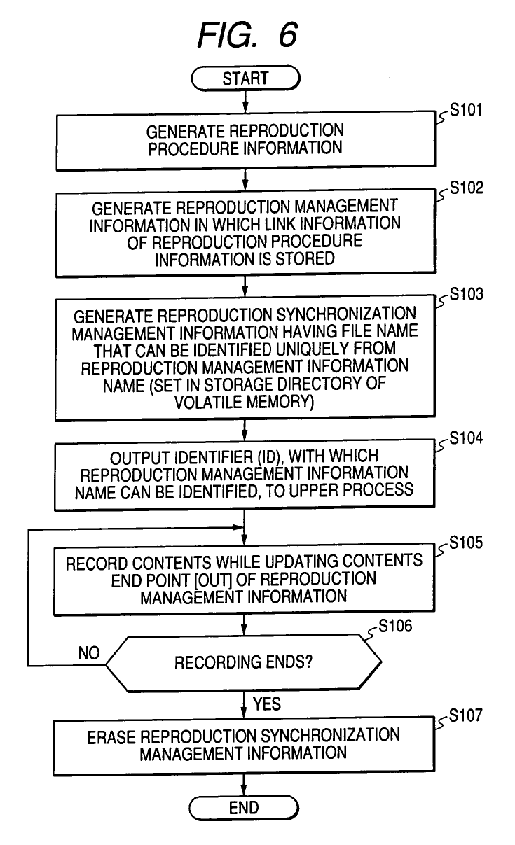

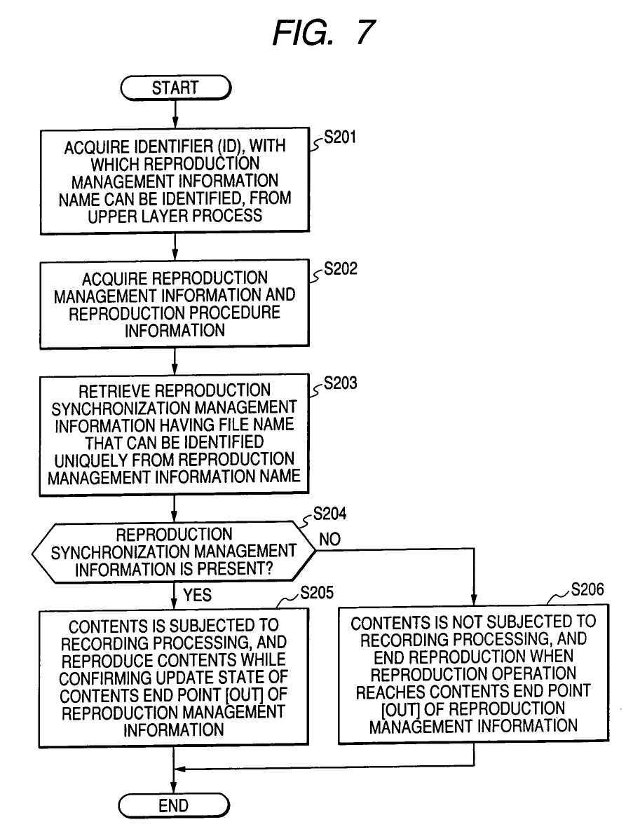

Next, a contents recording processing procedure and a contents reproduction processing procedure in this embodiment will be explained with reference to flowcharts in FIGS. 6 and 7.

First, a processing procedure of a recording control process will be explained with reference to FIG. 6. First, instep S101, the recording control process performs generation processing for reproduction procedure information. More specifically, in the information detection device 520 (see FIG. 5), the recording control process extracts time information, video management information, and audio management information from video PES data and audio PES data of video/voice data (contents) and stores these pieces of information in reproduction procedure information in association with the contents.

Next, in step S102, the recording control process generates reproduction management information linked to the reproduction procedure information, more specifically, reproduction management information in which a reproduction procedure information name (Name) is registered.

Next, in step S103, the recording control process generates reproduction synchronization management information. The recording control process sets a reproduction synchronization management information name (file name), which is decided uniquely from a reproduction management information name (file name) to be set in reproduction management information, in the reproduction synchronization management information. The recording control process records this reproduction synchronization management information in a directory that is automatically erased at the time of system startup or at the time of system shutdown. For example, the recording control process stores the reproduction synchronization management information in a volatile memory.

In step S104, the recording control process outputs an identifier ID_A, with which a reproduction management information name (file name) can be identified, to an upper layer process (application) that does not execute direct control concerning recording and reproduction.

In step S105, the recording control process stores contents in a recording medium (hard disk) while sequentially updating a content send point [OUT] of the reproduction control information. When contents recording end is confirmed in step S106, the recording control process proceeds to step S107 and erases the reproduction synchronization management information generated in step S103 to end the processing.

Next, a contents reproduction processing procedure to be executed by the reproduction control process will be explained with reference to FIG. 7.

In step S201, the reproduction control process acquires an identifier (ID), with which a reproduction control information name can be identified, from an upper layer process that does not perform control concerning recording and reproduction. In step S202, the reproduction control process specifies reproduction management information corresponding to contents to be reproduced on the basis of the acquired identifier (ID) and acquires reproduction procedure information of contents to be reproduced with reference to this reproduction management information.

Next, in step S203, the reproduction control process specifies a reproduction synchronization management information name from the reproduction management information name. In step S204, the reproduction control process confirms presence or absence of reproduction synchronization management information, and if reproduction synchronization management information is detected, proceeds to step S205.

In step S205, the reproduction control process judges that contents are being recorded and performs reproduction control necessary for reproduction of contents being recorded simultaneously in accordance with reproduction management information and reproduction procedure information, for example, controls reproduction processing while confirming an update state of a recording end point [OUT] in the reproduction management information. In the case in which a reproduction position has reached the recording end point [OUT] in the reproduction management information, the reproduction control process performs processing such as pause (suspension).

On the other hand, if it is judged in step S204 that reproduction synchronization management information is absent, the reproduction control process proceeds to step S206, and judges that contents to be reproduced are recorded contents and performs reproduction control necessary for reproduction of the recorded contents in accordance with reproduction management information and reproduction procedure information. For example, in the case in which a reproduction operation has reached a recording end point in the reproduction management information, the reproduction control process performs control of shifting to reproduction end processing.

Note that in the processing of step S205 in the case in which presence of reproduction synchronization management information corresponding to contents to be reproduced is confirmed, the reproduction control process confirms presence of reproduction synchronization management information periodically. In the case in which the reproduction control process confirms that reproduction synchronization management information is erased following the end of recording processing, the reproduction control process judges that recording of contents being reproduced has ended. After that, the reproduction control process shifts to reproduction control of contents as recorded contents.

In this way, according to the constitution of the invention, the recording control process for executing content recording processing generates reproduction synchronization management information, which has a reproduction synchronization management information name that is decided uniquely from a reproduction management information name, on the basis of reproduction management information set for contents to be recorded and outputs an identifier (ID), with which the reproduction management information can be identified, to an upper layer process. The reproduction control process is allowed to acquire reproduction management information on the basis of the identifier (ID), with which the reproduction management information can be identified, and extract reproduction synchronization management information on the basis of the reproduction management information name, and judge whether contents to be reproduced is being recorded to execute control of a reproduction process. Thus, even if the number of contents to be recorded simultaneously or the number of contents to be reproduced simultaneously increases, it is possible to cope with both a reproduction operation of contents being recorded and a reproduction operation of recorded contents simply by increasing the recording control process and the reproduction control process according to the increase in the number of contents.

In addition, reproduction synchronization management information is stored in a directory that is automatically erased at the time of system startup or a volatile memory that is erased at the time of power off. Thus, even in the case in which the recording control process, which generated reproduction synchronization management information, has stopped due to power supply interruption or the like during execution, the reproduction synchronization management information is reset after restart. Thus, since data indicating that contents is being recorded does not remain as in the conventional constitution, the reproduction control process is prevented from performing reproduction control misunderstanding that contents are contents being recorded simultaneously.

### Second Embodiment

In the first embodiment, the constitution example is explained in which reproduction synchronization management information is stored in a directory that is automatically erased at the time of system startup or at the time of system shutdown, for example, a volatile memory, whereby the reproduction synchronization management information is prevented from remaining at the time of restart after power supply interruption.

Next, as a second embodiment, an example will be explained in which recording management information, in which link information indicating reproduction synchronization management information is set, is generated, and compulsory erasing processing for the reproduction synchronization management information is executed on the basis of recording management information.

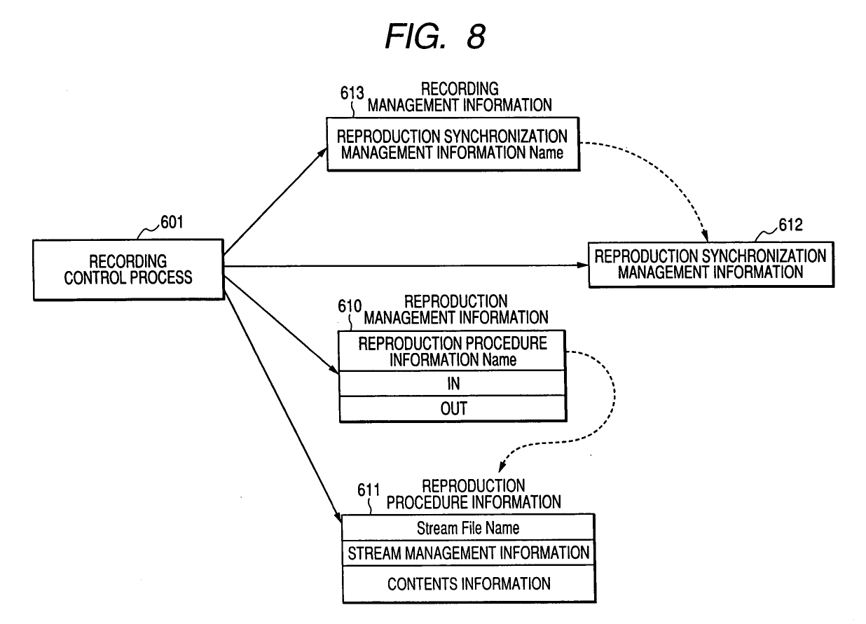

FIG. 8 shows a process configuration example of the second embodiment. Note that FIG. 8 shows only information related to processing based upon a recording control process 601. In the second embodiment, in an actual process configuration, there is a reproduction control process as in the process configuration of FIG. 4, and there is an upper layer process (application) above the reproduction control process. Since processing for these processes is the same as that in the first embodiment, the processing will not be explained. As in the preceding embodiment, a recording control process and a reproduction control process are set following generation of new contents recording or reproduction processing and are erased following the end of a process.

In this embodiment, a hardware configuration is the same as the configuration of FIG. 5. However, reproduction synchronization management information is not stored in the memory 542 but can be stored in a nonvolatile memory such as the hard disk 523. In other words, a storage area for reproduction synchronization management information can be set as a data storage area other than a directory that is automatically erased at the time of system startup or at the time of system shutdown or a memory area that is erased by power off.

Processing of the recording control process 601 will be explained. At the time of contents recording, in the information detection device 520 (see FIG. 5), the recording control process 601 extracts time information, video management information, audio management information from video PES data and audio PES data of video/voice data (contents) and records these pieces of information in reproduction procedure information 611 in association with the contents to perform generation processing for the reproduction procedure information 611.

The recording control process 601 registers the reproduction procedure information 611 in reproduction management information 610 and executes association (link) processing for the reproduction procedure information 611 and the reproduction management information 610. As a start point [In] of contents of reproduction management information, predetermined time information is set in a contents recording start point as contents start point information. An end point [Out] of contents is time data that is updated as contents recording processing progresses.

Moreover, in the case of starting recording of contents, the recording control process 601 generates reproduction synchronization management information 612, records recording management information 613, with which the recording control process 601 can be identified uniquely, and registers link information indicating the reproduction synchronization management information 612 in the recording management information 613. The recording control process 601 erases the reproduction synchronization management information 612 and the recording management information 613 at the time when contents recording ends.

A reproduction synchronization management information name (file name) to be set in the reproduction synchronization management information 612 is set as a name that is uniquely decided from a reproduction management information name (file name) to be set in the corresponding reproduction management information 610. Reproduction synchronization management information can be extracted from the reproduction synchronization management information name.

As described before, the reproduction synchronization management information 612 indicates that a contents recording process by the recording control process 601 is being executed. When the recording process ends, both the reproduction synchronization management information 612 and the recording management information 613 are erased.

The recording control process 601 outputs an identifier (ID), with which the reproduction management information 610 can be identified, to an upper layer process (application) (not shown) that does not execute direct control concerning recording and reproduction. The upper layer process (application) manages an identifier (ID) with which reproduction management information can be identified.

Reproduction processing by a reproduction control process is the same as that in the first embodiment explained before. The reproduction control process acquires the identifier (ID), with which reproduction management information can be identified, from the upper layer process (application) and executes reproduction processing based upon reproduction management information and reproduction procedure information. In addition, the reproduction control process judges whether recording processing for contents is executed on the basis of presence or absence of reproduction synchronization management information and performs reproduction control according to the judgment.

In this embodiment, at the time of system startup, the recording control process 601 executes search for finding whether recording management information is present. In the case in which the recording management information 613 is present, regarding that power supply interruption such as service interruption has occurred during a recording operation, the recording control process 601 refers to link information in the detected recording management information 613, and specifies the reproduction synchronization management information 612 on the basis of the link information. In the case in which the reproduction synchronization management information 612 is present, the recording control process 601 erases the reproduction synchronization management information 612. Next, the recording control process 601 executes erasing of the recording management information 613 having link information of reproduction synchronization management information.

In this way, according to the constitution of this embodiment, the recording control process, which executes contents recording processing, generates reproduction synchronization management information having a reproduction synchronization management information name, which is decided uniquely from a reproduction management information name, and recording management information having link information to the reproduction synchronization management information on the basis of reproduction management information to be set for contents to be recorded, detects presence or absence of recording management information at the time of system startup, and in the case in which recording management information is detected, detects reproduction synchronization management information on the basis of link information in the detected recording management information, erases the detected reproduction synchronization management information, and performs erasing of the detected recording management information. Thus, it is unnecessary to store reproduction synchronization management information in a directory, which is automatically erased at the time of system startup, or a volatile memory as in the first embodiment. For example, even if reproduction synchronization management information is stored in a hard disk storing contents, erasing processing by the recording control process is executed at the time of system startup. Therefore, the reproduction control processing is prevented from executing wrong control on the basis of remaining data indicating that contents are being recorded.

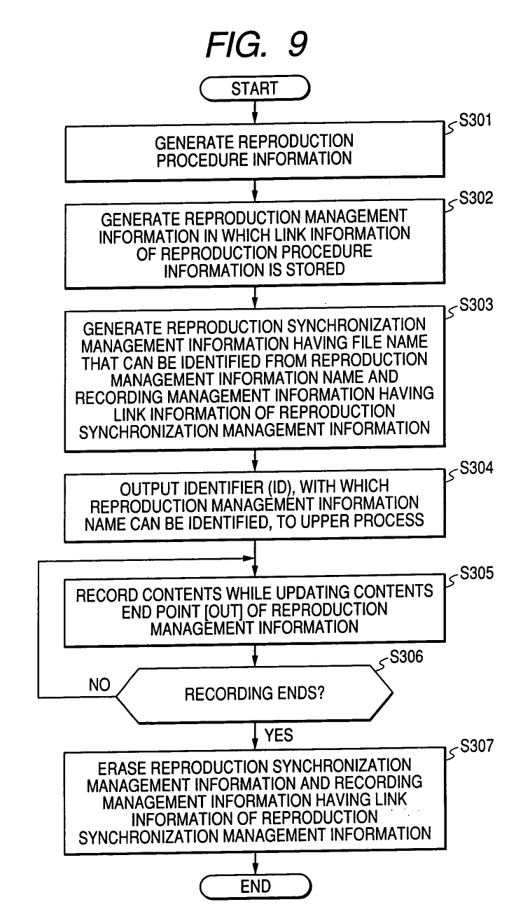

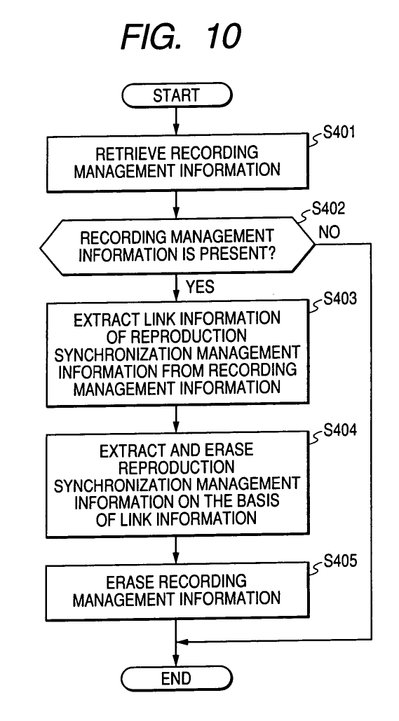

Next, a procedure for contents recording processing and a processing procedure of a recording control process at the time of system startup in this embodiment will be explained with reference to flowcharts in FIGS. 9 and 10.

First, the processing procedure of a recording control process will be explained with reference to FIG. 9. First, in step S301, the recording control process performs generation processing for reproduction procedure information. More specifically, in the information detection device 520 (see FIG. 5), the recording control process extracts time information, video management information, and audio management information from video PES data and audio PES data of video/voice data (contents) and stores these pieces of information in reproduction procedure information in association with the contents.

Next, in step S302, the recording control process generates reproduction management information linked to the reproduction procedure information, more specifically, reproduction management information in which a reproduction procedure information name (Name) is registered.

Next, in step S303, the recording control process generates reproduction synchronization management information and recording management information having link information of the reproduction synchronization management information. A reproduction synchronization management information name (file name), which is uniquely decided from a reproduction management information name (file name) set in the reproduction management information, is set in the reproduction synchronization management information. This reproduction synchronization management information is stored in, for example, a hard disk in which contents are recorded.

In step S304, the recording control process outputs an identifier ID_A, with which the reproduction management information name (file name) can be identified, to an upper layer process (application) that does not execute direct control concerning recording and reproduction.

In step S305, the recording control process stores contents in a recording medium (hard disk) while sequentially updating a contents end point [OUT] of the reproduction management information. When contents recording end is confirmed in step S306, the recording control process proceeds to step S307 and erases the reproduction synchronization management information generated in step S303 and the recording management information having link information of the reproduction synchronization management information to end the processing.

Next, a processing procedure of the recording control process at the time of system startup will be explained with reference to a flowchart of FIG. 10.

In step S401, the recording control process executes searching processing for finding whether recording management information is present. If recording management information is not present (No in step S402), the processing ends.

If recording management information is present (Yes in step S402), in step S403, the recording control process refers to link information in the detected recording management information and extracts reproduction synchronization management information on the basis of the link information.

Next, in step S404, the recording control process erases the extracted reproduction synchronization management information. In step S405, the recording control process executes erasing processing for recording management information having link information of the reproduction synchronization management information.

According to the constitution of this embodiment, at the time of system startup, erasing of reproduction synchronization management information and erasing processing for recording management information having link information of the reproduction synchronization management information are executed by the recording control process. Thus, it becomes possible to store the reproduction synchronization management information in a recording medium such as a hard disk without setting the reproduction synchronization management information to be automatically erased due to power supply interruption such as service interruption as in the first embodiment, and occurrence of wrong control by the reproduction control process is prevented.

Note that, the above-mentioned embodiments are explained assuming that a contents storage medium is mainly a hard disk. However, the invention is also applicable in a constitution in which contents are recorded in other storage media, for example, various storage media such as a DVD, an optical disk, and a flash memory.

The present invention has been explained in detail with reference to the specific embodiments. However, it is obvious that those skilled in the art can perform modification and substitution of the embodiments within a range not departing from the sprit of the invention. In other words, the invention has been disclosed in a form of illustration and should not be interpreted limitedly. In order to judge the spirit of the invention, the column of patent claims described in the beginning should be taken into consideration.

Note that it is possible to execute the series of processing explained in the specification with hardware or software or a composite constitution of the hardware and the software. In the case in which processing by software is executed, it is possible to install a program recording a processing sequence in a memory in a computer incorporated in dedicated hardware to cause the computer to execute the program or install a program in a general purpose computer capable of executing various kinds of processing to cause the computer to execute the program.

For example, a program can be recorded in a hard disk or a ROM (Read Only Memory) serving as a recording medium in advance. Alternatively, a program can be temporarily or permanently stored (recorded) in a removable recording medium such as a flexible disk, a CD-ROM (Compact Disc Read Only Memory), an MO (Magneto optical) disk, a DVD (Digital Versatile Disc), a magnetic disk, or a semiconductor memory. Such a removable recording medium can be provided as so-called package software.

Note that, other than being installed in a computer from the removable recording medium described above, a program can be transferred to a computer by radio or transferred to a computer by wire via a LAN (Local Area Network) or a network such as the Internet from a download site. The computer can receive the program transferred in that way and install the program in a recording medium such as a hard disk incorporated therein.

Note that, other than being executed in time series in accordance with the description, the various kinds of processing described in the specification may be executed in parallel or individually according to processing capability of an apparatus executing the processing or as required. In addition, in this specification, a system is a logical set constitution of plural apparatuses and is not limited to a system in which apparatuses of respective constitutions are provided in an identical housing.

### INDUSTRIAL APPLICABILITY

As explained above, according to the constitution of the invention, the recording control process for executing contents recording processing becomes capable of generating reproduction synchronization management information having a reproduction synchronization management information name, which is uniquely decided from a reproduction management information name, on the basis of reproduction management information to be set for contents to be recorded, and the reproduction control process becomes capable of extracting reproduction synchronization management information on the basis of a reproduction management information name and judging whether contents to be reproduced are being recorded to execute control of a reproduction process. Even if the number of contents to be recorded simultaneously increases or the number of contents to be reproduced simultaneously increases, it is possible to cope with both a reproduction operation for contents being recorded and a reproduction operation for recorded contents simply by increasing the recording control process and the reproduction control process according to the increased number of contents, respectively.

According to the constitution of the invention, the recording control process outputs an identifier (ID), with which reproduction management information can be identified, to an upper layer process. The reproduction control process becomes capable of acquiring reproduction management information on the basis of the identifier (ID), with which reproduction management information can be identified, and extracting reproduction synchronization management information on the basis of a reproduction management information name of the acquired reproduction management information, and judging whether contents to be reproduced are being recorded to execute control for a reproduction process.

According to the constitution of the invention, reproduction synchronization management information is stored in a directory that is automatically erased at the time of system startup or a nonvolatile memory that is erased at the time of power off. Thus, even in the case in which a recording control process, which has generated reproduction synchronization management information, stops during execution due to power supply interruption or the like, the reproduction synchronization management information is reset after restart. Therefore, since data indicating that contents are being recorded does not remain as in the conventional constitution, the reproduction control process is prevented from performing reproduction control misunderstanding that the contents are contents being simultaneously recorded.

According to the constitution of the second embodiment of the invention, erasing of reproduction synchronization management information and erasing processing for recording management information having link information of the reproduction synchronization management information are executed by the recording control process at the time of system startup. Thus, it becomes possible to store reproduction synchronization management information in a recording medium such as a hard disk without setting the reproduction synchronization management information to be automatically erased due to power supply interruption such as service interruption, and occurrence of wrong control according to the reproduction control process is prevented.

1. An information recording and reproduction processing apparatus that executes data recording and reproduction processing, comprising:
storing means for data recording;
a recording control process execution unit that generates reproduction management information including at least data recording end position information and executes data recording control for the storing means; and
a reproduction control process execution unit that executes reproduction control processing for data, which is readout from the storing means, on the basis of the reproduction management information, characterized in that
the recording control process execution unit has a constitution for, in the case of data recording processing, generating reproduction synchronization management information indicating that recording processing for data is in progress, associating the reproduction synchronization management information with the reproduction management information, and executing processing for recording the generated reproduction synchronization management information in a directory that is automatically erased at the time of system startup or at the time of system shutdown, and
the reproduction control process execution unit is constituted to, in the case of data reproduction processing, extract reproduction management information corresponding to reproduction data, execute retrieval processing for reproduction synchronization management information based upon the reproduction management information, judge whether data is being recorded on the basis of presence or absence of reproduction synchronization management information, and execute data reproduction control according to a result of the judgment.

2. An information recording and reproduction processing apparatus according to claim 1, characterized in that
the recording control process execution unit is constituted to execute processing for storing the reproduction synchronization management information in a volatile memory.

3. An information recording and reproduction processing apparatus according to claim 1, characterized in that
the recording control process execution unit is constituted to execute processing for setting a reproduction synchronization management information name, which is set in the reproduction synchronization management information, as a file name that can be identified uniquely from the reproduction management information name, and
the reproduction control process execution unit is constituted to specify a reproduction synchronization management information name on the basis of the reproduction management information name and execute retrieval processing for reproduction synchronization management information on the basis of the reproduction synchronization management information name.

4. An information recording and reproduction processing apparatus according to claim 1, characterized in that
the information recording and reproduction processing apparatus has an upper layer process execution unit that executes setting processing for the recording control process, the recording control process execution unit is constituted to generate an identifier (ID) with which the reproduction management information can be identified uniquely and output the generated identifier to an upper process execution unit,
the upper layer process execution unit is constituted to execute processing for storing the identifier (ID) in a storage unit and managing the identifier, and
the reproduction control process execution unit is constituted to execute processing for inputting the identifier (ID) from the upper process execution unit and acquiring the reproduction management information on the basis of the identifier (ID).

5. An information recording and reproduction processing apparatus according to claim 1, characterized in that the recording control process execution unit is constituted to execute recording of data to be an object of reproduction processing with respect to the storing means constituted by a nonvolatile memory and execute processing for storing the reproduction synchronization management information in a volatile memory different from the storing means.

6. An information recording and reproduction processing apparatus according to claim 1, characterized in that
the reproduction control processing execution unit is constituted to, in the case in which reproduction synchronization management information is detected, judge that data recording processing is in progress, execute control for reproduction processing while confirming an update state of a recording end point in reproduction management information, and, in the case in which a reproduction position reaches the recording end point in the reproduction management information, perform reproduction suspension processing.

7. An information recording and reproduction processing apparatus according to claim 1, characterized in that
the reproduction control process execution unit is constituted to, in the case in which reproduction synchronization management information is not detected, judge that data recording processing is not in progress, execute reproduction control for data as recorded data, and, in the case in which a reproduction position reaches a recording end point in reproduction management information, execute control for shifting to reproduction ending processing.

8. An information recording and reproduction processing apparatus according to claim 1, characterized in that
the reproduction control process execution unit is constituted to, in the case in which reproduction synchronization management information is detected, periodically verify presence or absence of the reproduction synchronization management information, in the case in which the reproduction synchronization management information is erased, execute reproduction control for data as recorded data, and, in the case in which a reproduction position reaches a recording end point in reproduction management information, execute control for shifting to reproduction ending processing.

9. An information recording and reproduction processing apparatus that executes data recording and reproduction processing, comprising:
storing means for data recording;
a recording control process execution unit that generates reproduction management information including at least data recording end position information and executes data recording control for the storing means; and
a reproduction control process execution unit that executes reproduction control processing for data, which is read out from the storing means, on the basis of the reproduction management information, characterized in that
the recording control process execution unit has a constitution for, in the case of data recording processing, executing processing for generating reproduction synchronization management information indicating that recording processing for data is in progress and recording management information having link information of the reproduction synchronization management information and storing the generated reproduction synchronization management information and recording management information in storing means, and
executing retrieval processing for recording management information at the time of system startup, extracting and erasing reproduction synchronization management information on the basis of link information of extracted recording management information, and executing erasing processing for the extracted recording management information, and
the reproduction control process execution unit is constituted to, in the case of data reproduction processing, extract reproduction management information corresponding to reproduction data, execute retrieval processing for reproduction synchronization management information based upon the reproduction management information, judge whether data is being recorded on the basis of presence or absence of reproduction synchronization management information, and execute data reproduction control according to a result of the judgment.

10. An information recording and reproduction processing apparatus according to claim 9, characterized in that
the recording control process execution unit is constituted to execute recording of data to be an object of reproduction and recording of the reproduction synchronization management information and recording management information with respect to the storing means constituted by a nonvolatile memory.

11. An information recording and reproduction processing apparatus according to claim 9, characterized in that
the recording control process execution unit is constituted to execute processing for setting a reproduction synchronization management information name, which is set in the reproduction synchronization management information, as a file name that can be identified uniquely from the reproduction management information name, and
the reproduction control process execution unit is constituted to specify a reproduction synchronization management information name on the basis of the reproduction management information name and execute retrieval processing for reproduction synchronization management information on the basis of the reproduction synchronization management information name.

12. An information recording and reproduction processing apparatus according to claim 9, characterized in that
the information recording and reproduction processing apparatus has an upper layer process execution unit that executes setting processing for the recording control process,
the recording control process execution unit is constituted to generate an identifier (ID) with which the reproduction management information can be identified uniquely and output the generated identifier to an upper process execution unit,
the upper layer process execution unit is constituted to execute processing for storing the identifier (ID) in a storage unit and managing the identifier, and
the reproduction control process execution unit is constituted to execute processing for inputting the identifier (ID) from the upper process execution unit and acquiring the reproduction management information on the basis of the identifier (ID).

13. An information recording and reproduction processing apparatus according to claim 9, characterized in that
the reproduction control processing execution unit is constituted to, in the case in which reproduction synchronization management information is detected, judge that data recording processing is in progress, execute control for reproduction processing while confirming an update state of a recording end point in reproduction management information, and, in the case in which a reproduction position reaches the recording end point in the reproduction management information, perform reproduction suspension processing.

14. An information recording and reproduction processing apparatus according to claim 9, characterized in that
the reproduction control process execution unit is constituted to, in the case in which reproduction synchronization management information is not detected, judge that data recording processing is not in progress, execute reproduction control for data as recorded data, and, in the case in which a reproduction position reaches a recording end point in reproduction management information, execute control for shifting to reproduction ending processing.

15. An information recording and reproduction processing apparatus according to claim 9, characterized in that
the reproduction control process execution unit is constituted to, in the case in which reproduction synchronization management information is detected, periodically verify presence or absence of the reproduction synchronization management information, in the case in which the reproduction synchronization management information is erased, execute reproduction control for data as recorded data, and, in the case in which a reproduction position reaches a recording end point in reproduction management information, execute control for shifting to reproduction ending processing.

16. An information recording processing method for executing data recording processing, characterized by comprising:
a reproduction synchronization management information generation step of, in the case of data recording processing, generating reproduction synchronization management information indicating that recording processing for data is in progress;
an association processing step of associating the reproduction synchronization management information to the reproduction management information; and
a reproduction synchronization management information recording step of executing processing for recording the reproduction synchronization management information in a directory that is automatically erased at the time of system startup or at the time of system shutdown.

17. An information recording processing method according to claim 16, characterized in that
the reproduction synchronization management information recording step is a step of executing processing for storing the reproduction synchronization management information in a volatile memory.

18. An information recording processing method according to claim 16, characterized in that
the association processing step is a step of executing processing for setting a reproduction synchronization management information name, which is set in the reproduction synchronization management information, as a file name that can be identified uniquely from the reproduction management information name.

19. An information recording processing method according to claim 16, characterized in that
the information recording processing method further comprises:
a step of generating an identifier (ID) with which the reproduction management information can be identified uniquely and outputting the generated identifier to an upper process execution unit; and
a step of storing the identifier (ID) in a storing unit and managing the identifier in the upper layer process execution unit.

20. An information recording processing method for executing data recording processing, characterized by comprising:
a management information generation step of, in the case of data recording processing, generating reproduction synchronization management information indicating that recording processing for data is in progress and recording management information having link information of the reproduction synchronization management information;
a management information recording processing step of storing the generated reproduction synchronization management information and recording management information in storing means; and
a management information erasing step of, at the time of system start up, executing retrieval processing for recording management information, extracting and erasing reproduction synchronization management information on the basis of link information of extracted recording management information, and executing erasing processing for the extracted recording management information.

21. An information recording processing method according to claim 20, characterized in that
the management information recording processing step executes recording of data to be an object of reproduction processing and recording of the reproduction synchronization management information and recording management information with respect to the storing means constituted by a nonvolatile memory.

22. An information recording processing method according to claim 20, characterized in that
the information recording processing method further comprises:
a step of generating an identifier (ID) with which the reproduction management information can be identified uniquely and outputting the generated identifier to an upper process execution unit; and
a step of storing the identifier (ID) in a storing unit and managing the identifier in the upper layer process execution unit.

23. An information reproduction processing method for executing data reproduction processing, characterized by comprising:
a reproduction management information extraction step of, in the case of data reproduction processing, extracting reproduction management information corresponding to reproduction data;
a reproduction synchronization management information retrieval step of executing retrieval processing for reproduction synchronization management information that can be identified uniquely from extracted reproduction management information; and
a reproduction control step of executing reproduction control for data being recorded or reproduction control processing for data not being recorded.

24. An information reproduction processing method according to claim 23, characterized in that
a reproduction synchronization management information name set in the reproduction synchronization management information is a file name that is identified uniquely from the reproduction management information name, and
the reproduction synchronization management information retrieval step is a step of specifying a reproduction synchronization management information name on the basis of the reproduction management name and executing retrieval processing for reproduction synchronization management information on the basis of the reproduction synchronization management information name.

25. An information reproduction processing method according to claim 23, characterized in that
the reproduction control step is a step of, in the case in which reproduction synchronization management information is present, judging that data recording processing is in progress and executing control for reproduction processing while confirming an update state of a recording end point in reproduction management information, and, in the case in which a reproduction position reaches the recording end point in the reproduction management information, executing control processing for performing suspension processing.

26. An information reproduction processing method according to claim 23, characterized in that
the reproduction control step is a step of, in the case in which reproduction synchronization management information is not present, judging that data recording processing is not in progress and executing reproduction control for data as recorded data, and, in the case in which a reproduction position reaches a recording end point in reproduction management information, executing control for shifting to reproduction ending processing.

27. An information reproduction processing method according to claim 23, characterized in that
the information reproduction processing method further comprises:
a step of, in the case in which reproduction synchronization management information is present, periodically verifying presence or absence of reproduction synchronization management information, in the case in which the reproduction synchronization management information is erased, executing reproduction control for data as recorded data, and, in the case in which a reproduction position reaches a recording end point in reproduction management information, executing control for shifting to reproduction end processing.

28. An information reproduction processing method according to claim 23, characterized in that
the reproduction management information extraction step is a step of inputting an identifier (ID), with which the reproduction management information can be identified uniquely, from an upper process execution unit and executing processing for acquiring the reproduction management information on the basis of the identifier (ID).

29. A computer program for executing data recording processing, characterized by comprising:
a reproduction synchronization management information generation step of, in the case of data recording processing, generating reproduction synchronization management information indicating that recording processing for data is in progress;
an association processing step of associating the reproduction synchronization management information to the reproduction management information; and
a reproduction synchronization management information recording step of executing processing for recording the reproduction synchronization management information in a directory that is automatically erased at the time of system startup or at the time of system shutdown.

30. A computer program for executing data recording processing, characterized by comprising:
a management information generation step of, in the case of data recording processing, generating reproduction synchronization management information indicating that recording processing for data is in progress and recording management information having link information of the reproduction synchronization management information;
a management information recording processing step of storing the generated reproduction synchronization management information and recording management information in storing means; and
a management information erasing step of, at the time of system start up, executing retrieval processing for recording management information, extracting and erasing reproduction synchronization management information on the basis of link information of extracted recording management information, and executing erasing processing for the extracted recording management information.

31. A computer program for executing data reproduction processing, characterized by comprising:
a reproduction management information extraction step of, in the case of data reproduction processing, extracting reproduction management information corresponding to reproduction data;
a reproduction synchronization management information retrieval step of executing retrieval processing for reproduction synchronization management information that can be identified uniquely from extracted reproduction management information; and
a reproduction control step of executing reproduction control for data being recorded or reproduction control processing for data not being recorded on the basis of presence or absence of the reproduction synchronization management information.
